(19) United States
(12) Patent Application Publication
(10) Pub. No.: US 2021/0133671 A1
(43) Pub. Date: May 6, 2021

(54) SYSTEM AND METHOD FOR IMPLEMENTING JUST-IN-TIME INVENTORY REPLENISHMENT

(71) Applicant: Walmart Apollo, LLC, Bentonville, AR (US)

(72) Inventors: John J. O'BRIEN, Farmington, AR (US); Donald R. HIGH, Noel, MO (US); Brian MCHALE, Oldham (GB)

(73) Assignee: Walmart Apollo, LLC, Bentonville, AR (US)

(21) Appl. No.: 17/143,810

(22) Filed: Jan. 7, 2021

Related U.S. Application Data
(63) Continuation of application No. 16/449,680, filed on Jun. 24, 2019, now abandoned.
(60) Provisional application No. 62/689,753, filed on Jun. 25, 2018.

(51) Int. Cl. G06Q 10/08; B65G 1/137; G06Q 30/02

(52) U.S. Cl. CPC G06Q 10/087; G06Q 30/0202; B65G 1/1371; B65G 1/1375

(57) ABSTRACT

The present invention is directed to systems and methods for Just-in-Time (JIT) inventory replenishment. A computer-implemented method may include: analyzing, by a sales data engine, historical sales data of products to obtain sales patterns of the products; determining a demand and a time to be replenished for each of the products; detecting, by a sensor at a retail store, an arrival of a delivery vehicle loaded with the products; autonomously unloading, via a conveyor system, the products from the delivery vehicle to a queue area of the retail store; scanning and identifying the products; ranking and ordering, by an inventory replenishment engine, the products to determine a quantity, a priority and a time to dispense each of the products; autonomously sorting the products into a plurality of carts; moving the products from the queue area to a dispensing area; and alerting assistants to automatically restock the products to sales floor.

### CROSS REFERENCE TO RELATED APPLICATION

This patent application claims the priority to U.S. Provisional Application Ser. No. 62/689,753, filed Jun. 25, 2018, the contents of which is incorporated by reference herein.

### BACKGROUND

### 1. Technical Field

The present disclosure relates to inventory management, and more specifically a system and method for inventory control.

### 2. Introduction

An accurate system and method for maintaining quantities of various products in an inventory can be important to retail stores. It is critically important to monitor and control the inventory to maintain an appropriate inventory of designated products to meet the actual demand of consumers. Upon a delivery vehicle's arriving at a backroom or a warehouse of a retail store, a retail store inventory system may monitor and control transit of products unloading from the delivery vehicle to a backroom and from the backroom to sales floor of the retail store. Many factors can affect accurate inventory information and product movement in the retail store. For example, the retail store inventory system may not accurately determine priorities and quantities of inventory of various products needed for replenishment, and not properly determine when to replenish various products to the sales floor based on sales trends of the products. Moreover, there may be some delays in the movement of the products from the delivery vehicle to the sales floor. As such, the efficiency of the retail store inventory system may be low. Computing power and resources of the retail store inventory system may not be utilized fully.

There is a need to more efficiently and effectively manage inventory replenishment in a retail store so as to provide an automatic, quick, and accurate product transition for different processes of inventory replenishment and to assure that shelves of the retail store are timely and regularly stocked with a suitable number of products based upon an anticipated demand.

### SUMMARY

An example method of performing concepts disclosed herein can include: analyzing, by a sales data engine executed by a processor of a computing device, historical sales data of products to obtain sales pattern of each of the products; determining, by the sales data engine and based on the sales pattern of each of the products, a demand and a time to be replenished for each of the products; detecting, by at least one sensor of a retail store, an arrival of a delivery vehicle loaded with the products; autonomously unloading, via a first conveyor system, the products from the delivery vehicle to a queue area of the retail store; scanning, by a product unloading scanner in communication with the processor, the products to identify each of the product and update product information of each of the products, wherein the product information comprising a product name, a product code, a location code, a category, a department, a priority to be dispensed, a quantity of the product to be dispensed, a time to be dispensed, a scheduled pickup time, and a supplier; ranking and ordering, by an inventory replenishment engine executed by the processor of the computing device and based on the sales pattern and the stock status of each of the products, each of the products to determine a priority, a quantity, and a time for products to be dispensed; autonomously sorting, based on the priority, the quantity and the time to be dispensed, the products into a plurality of carts; autonomously moving, the products from the queue area to a dispensing area; and alerting, based on the product information of the products, unmanned ground vehicles to automatically restock the products to the sales floor.

An example system for implementing Just-In-Time (JIT) inventory replenishment according to the concepts and principles disclosed herein can include: one or more sensors at a retail store, wherein at least one sensor is configured to detect an arrival of a delivery vehicle loaded with products; a product unloading scanner; one or more of unmanned ground vehicles; a computing device, comprising: a processor; and non-transitory computer-readable storage medium having instructions stored which, when executed by the processor, cause the processor to perform operations comprising: analyzing, by a sales data engine executed by the processor, historical sales data of products to obtain sales pattern of each of the product; determining, by the sales data engine and based on the sales pattern of each of the product, a demand and a time to be replenished for each of the products; upon detecting the arrival of a delivery vehicle, autonomously unloading, by a first conveyor system, the products from the delivery vehicle to a queue area of the retail store; scanning, by a product unloading scanner in communication with the processor, the products to identify the products and to update product information of each of the products, wherein the product information comprising a product name, a product code, a location code, frozen status, a product category, a product department, a priority to be dispensed, a quantity of the product to be dispensed, a time to be dispensed, a scheduled pickup time, and a supplier; ranking and ordering, by an inventory replenishment engine executed by the processor of the computing device and based on the sales pattern and stock status of each of the products, each of the products to determine a priority, a quantity, and a time for products to be dispensed; autonomously sorting the products into a plurality of carts, based on the priority, the quantity, and the time to be dispensed for products; autonomously moving, based on the priority, the quantity, and the time to be dispensed, the products from the queue area to a dispensing area; and alerting, based on the product information of the products, unmanned ground vehicles to automatically restock the products to the sales floor.

Additional features and advantages of the disclosure will be set forth in the description which follows, and in part will be obvious from the description, or can be learned by practice of the herein disclosed principles. The features and advantages of the disclosure can. be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

Example embodiments of this disclosure are illustrated by way of an example and not limited in the figures of the accompanying drawings, in which like references indicate similar elements and in which:

FIG. 1 is a diagram illustrating an example system in accordance with some example embodiments of the present invention;

FIG. 2 is a diagram illustrating an example unmanned ground vehicle in accordance with some embodiments of the present invention;

FIG. 3 is a flowchart diagram illustrating a process for implementing Just-in-Time inventory replenishment in accordance with some example embodiments of the present invention; and

FIG. 4 is a block diagram illustrating an example computer system in which some example embodiments may be implemented.

It is to be understood that both the foregoing description and the following detailed description are exemplary and explanatory and are intended to provide further explanations of the invention as claimed only and are, therefore, not intended to necessarily limit the scope of the disclosure.

### DETAILED DESCRIPTION

Various example embodiments of the present disclosure will be described in detail below with reference to the accompanying drawings. Throughout the specification, like reference numerals denote like elements having the same or similar functions. While specific implementations and example embodiments are described, it should be understood that this is done for illustration purposes only. Other components and configurations may be used without parting from the spirit and scope of the disclosure, and can be implemented in combinations of the variations provided. These variations shall be described herein as the various embodiments are set forth.

The concepts disclosed herein are directed to providing systems and methods of supply chain management and product locations. The disclosed systems and methods may control how different tasks and processes are organized and cooperate with each other in order to smooth a supply chain flow by aligning the inventory flow and reducing flow times from delivery vehicles to sales floor (e.g., store shelf, refrigerator, freezer, etc.) in a retail store. Embodiments of the invention may provide a fully automating system and process for products to move from a delivery vehicle to the sales floor.

The JIT inventory replenishment management system may be an one-touch inventory management system with a real-time inventory visibility including a constant flow of products such as from a delivery truck to a backroom, from the backroom to sales floor, etc. The JIT inventory replenishment management system may monitor and decide when a product needs to be dispensed in order to reduce flow times while minimizing storage and reducing space requirements. The monitoring and deciding may be based on product information related to a sales pattern, a current inventory on a shelf, a frozen status, a priority to be dispensed, a scheduled customer pickup time, and etc.

The JIT inventory replenishment management system (e.g., one-touch inventory management system) may eliminate the multiple touches of retail experiences used in traditional models. Moreover, the JIT inventory replenishment management system may significantly reduce operating costs, provide a way to streamline the entire inventory replenishment process, and reduce a cost of the inventory management of the retail store.

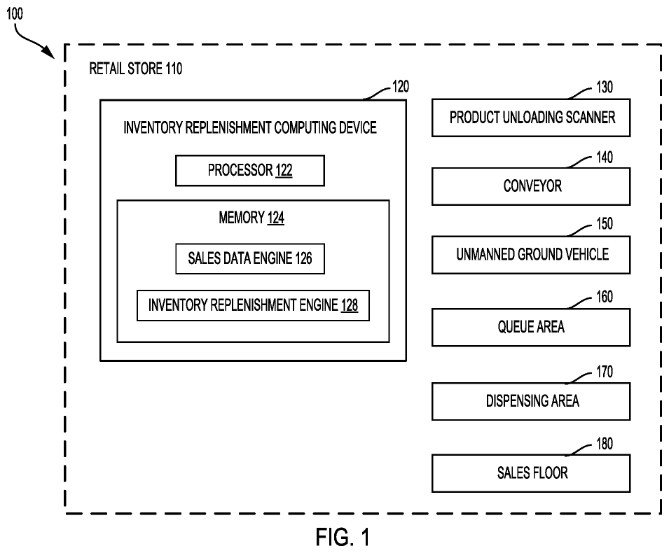

FIG. 1 is a block diagram illustrating an example JIT replenishment management system 100 in a retail store 110 in which some example embodiments of this disclosure may be implemented. The example replenishment management system 100 may include an inventory replenishment computing device 120, a product unloading scanner 130, a conveyor 140, an unmanned ground vehicle 150, a queue area 160, a dispensing area 170, a sales floor 180, database, and network (not shown).

The inventory replenishment computing device 120 may be a local server or a computer terminal located in the retail store 110. The inventor replenishment computing device 120 may include a processor 122 and a memory 124.

The example replenishment management system 100 may maintain a database storing product information for each of the products in the whole inventory of the retail store 110. The product information may include a product name, a product code, a location code (e.g., zone, aisle, shelf, bin, etc.), a frozen status or chilled status, a quantity of the product displayed on a sales floor, a category, a department, a priority to be dispensed, a quantity of the product to be dispensed, a time to be dispensed, a scheduled pickup time, stock status, and a product supplier. The product code of each of the products can be a Universal Product Code (UPC) code, a Quick Response (QR) code or other standard codes associated with the product information saved in the database. As products are delivered to the retail store 110 and unloaded, the product codes can be scanned and read by the product unloading scanner 130 and other scanners in the retail store 110. Once the product is scanned as received by the retail store 110, various information regarding the product may be retrieved. The location code of a product is where the product is displayed in the sales floor 180, such as zone, aisle, shelf, bin, etc. The stock status of a product may be indicated as “out of stock”, “low stock”, or “regular stock”. The frozen or chilled products may have a high unloading priority to be dispensed to the sales floor 180. The product information may further include product specifications, such as dimensions, weight, shape, color, etc. A scheduled pickup time may be associated with a pending order made by a customer. The database may store historical sales data of each product sold in the retail store 110.

A sales data engine 126 may be stored in the memory 124. The sales data engine 126 may be configured to analyze historical sales data of products sold in the retail store 110 to obtain sales patterns of the products. Further, the sales data engine 126 may determine which products are needed for replenishment along with a quantity and a time for product replenishment. A sales pattern of a particular product may include a sales amount, a sales rate, other sales information, or combinations of two or more of such sales information. The sales pattern of a product may be associated to timing information, such as a time of day, a time of week, a time of month, and a time of year. For example, some products might have higher sales amounts over weekends as compared to week days. Holidays may affect the sales patterns of certain products. Based on the product information, store status, sales data, etc., the JIT inventory replenishment engine 128 may determine how the product is unloaded and where it is sent in the retail store 110.

The JIT inventory replenishment engine 128 may be software modules or applications stored in the memory 124 and executed by the processor 122 of the inventory replenishment computing device 120. The JIT inventory replenishment engine 128 may be configured to rank the products to determine a priority, a time, a quantity of each product to be dispensed to the sales floor 180 of the retail store 110 or other locations, based on sales patterns and the product information of each of the products. The JIT inventory replenishment engine 128 may determine to order the products to be moved based on the sales pattern and current stock status of the products to be ordered.

Suppliers of the retail store 110 may receive orders and send a plurality of products to the retail store 110 via a vehicle delivery system based on results determined by the sales data engine 126. The vehicle delivery system may send a message to the JIT inventory replenishment management system 100. The message may comprise vehicle delivery information. The vehicle delivery information may include a delivery truck number (scanned bar code), loaded product status (name, quantity, scanned bar code, unloading priority, etc.), an unloading priority, frozen status, etc. The unloading priority may be classified as different levels, such as urgent need (e.g., pickup order or out of stock products), required (e.g., low stock products), and general (e.g., normal sales, daily deliveries). The frozen status of a product shows whether a product is frozen or not. The vehicle delivery information may also include a scheduled leaving time and an estimated arrival time for the delivery vehicle traveling to the retail store 110. The plurality of products may be loaded into different areas of the delivery vehicle based on the unloading priority of each of the products.

In some embodiments, a plurality of sensors and other wireless communication devices may form a geo-fence around the retail store 110. A number of vehicle bays for the delivery vehicles may be located near backrooms of the retail store 110. Each of the vehicle bays may be assigned with a digital number, a letter, or other signs to be distinguished from each other. For example, the JIT replenishment management system 100 may detect the delivery vehicle within a predetermined distance around the retail store 110 when the delivery vehicle crosses the geo-fence of the retail store 110. Upon detecting the delivery vehicle within a predetermined distance around the retail store 110, the JIT replenishment management system 100 may automatically assign a vehicle bay for the delivery vehicle based on the vehicle delivery information, and send a message to the vehicle delivery system. The delivery vehicle or a driver of the delivery vehicle may automatically receive the message via the vehicle delivery system. Meanwhile, the conveyor 140 may be arranged and the unmanned ground vehicle 150 may be assigned to the assigned vehicle bay for assisting in unloading products. The unmanned ground vehicle 150 (e.g., robots) may be used for assisting in different tasks in the retail store 110.

In some embodiments, the delivery vehicle may have an onboard GPS sensor communicating with the vehicle delivery system. The vehicle delivery system may communicate with the delivery vehicle and monitor a location of the delivery vehicle in real time. When the vehicle delivery system detects that the delivery vehicle is within a predetermined distance around the retail store 110, the vehicle delivery system may send a message with an updated arrival time of the delivery vehicle to the inventory replenishment computing device 120. In one embodiment, the delivery vehicle may directly communicate with the JIT replenishment management system 100 for updating the arrival time.

In some embodiments, sensors or cameras may be installed nearby the vehicle bays for detecting arrivals of delivery vehicles. The sensors or cameras may also be used for communicating with control mechanism of the vehicle bays for automatically opening and closing the vehicle bay doors. When the sensors detect a delivery vehicle arriving at the assigned vehicle bay by reading and verifying a delivery vehicle number, the assigned vehicle bay door may be automatically opened for the delivery vehicle to park in.

The JIT replenishment management system 100 may use unmanned ground vehicles (UGVs) 150, which may be referred to as “robots” or “assistant,” to fulfill assigned tasks. For example, the assigned tasks may include moving products from the delivery vehicles and sending the products to the sales floor 180, and putting the products on shelves. Robots may have different functionalities for different assigned tasks. The unmanned ground vehicles 150 may include unmanned air vehicles (UAVs).

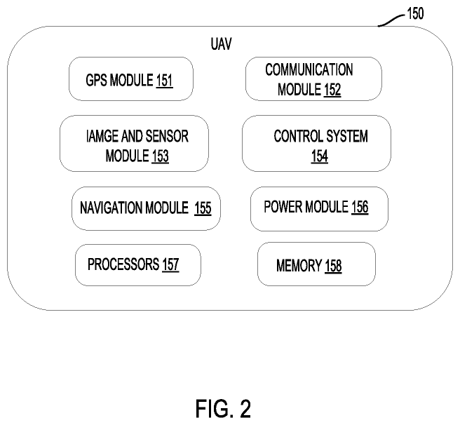

FIG. 2 is a block diagram of an example unmanned ground vehicle 150 in which some example embodiments may be implemented. The unmanned ground vehicle 150 may include a GPS module 151, a communication module 152, an image and sensor module 153, a control system 154, a navigation module 155, a power module 156, processors 157 and a memory (data storage) 158, and other mechanical components. The communication module 152 may allow the unmanned ground vehicles 150 to communicate with the inventory replenishment computing device 120 or processors 122 in the example JIT replenishment management system 100 for moving products. The communication module 152 may utilize cellular, radio frequency, near field communication, infrared, Bluetooth, Wi-Fi, satellite, or any other means for communications. The image and sensor module 153 may include one or more visual sensors, proximity sensors, and other types of sensors. The image and sensor module 153 and the GPS module 151 may be placed on one or more surfaces of the unmanned ground vehicle 150. The image and sensor module 153 and the GPS module 151 may determine positioning information for the unmanned ground vehicle 150, and guide the unmanned ground vehicle 150 to a destination in order to conduct specific functions or data analysis. The unmanned ground vehicle 150 can communicate with the JIT replenishment management system via the communication module 152. The unmanned ground vehicle 150 may use an in-store navigation system to route and move products to their destinations.

Referring to FIG. 1, the conveyor 140 may be controlled by a control device in communication with the processor 122 to automatically unload and move the products from the delivery vehicle to the queue area 160 of the retail store 110. In one embodiment, the conveyor 140 may be able to extend or attach to the delivery vehicle autonomously. In one embodiment, the products may be loaded on a conveyor module inside the delivery vehicle. The conveyor module of the delivery vehicle may be connected to the conveyor 140 and operate together with the conveyor 140 for unloading the products to the queue area 160.

The retail store 110 may include some functional areas or lanes such as a frozen or chilled lane for handling temperature sensitive products, such as frozen products or other types of products requiring a low storage temperature environment. If a vehicle bay is very close to a frozen or chilled lane in the backroom or queue area 160, or the sales floor 180 of the retail store 110, the vehicle bay may be specifically assigned for unloading temperature sensitive products. The chilled and frozen products can be quickly unloaded and moved to the frozen or chilled lane or directly to the sales floor 180. For example, the unmanned ground vehicle 150 may be able to identify and pick the temperature sensitive products, such as packages of frozen products, from the delivery vehicle. The unmanned ground vehicle 150 may further move the frozen products to a frozen or chilled lane in the dispensing area 170 or directly move them to the sales floor 180 for being put into freezers directly. The conveyor 140 may feed directly into the frozen or chilled storage area.

The product unloading scanner 130 may be on or at the delivery vehicle in an area where the products are off-loaded. The product unloading scanner 130 may be configured to communicate with the inventory replenishment computing device 120 to verify product information of each of the products. The product unloading scanner 130 may operate as a bar code scanner or a RFID reader to automatically identify products and record unloaded products. The scanned data can be transmitted directly to the inventory replenishment computing device 120. The inventory replenishment computing device 120 may look-up the products, update the product information, and verify correctness of the products.

In some embodiments, a plurality of the product unloading scanners 130 may be coupled with the conveyor 140. The product unloading scanners 130 can scan the product codes printed on the products and identify the products while the conveyor 140 continuously moves and transports the products to the queue area 160.

The product unloading scanners 130 may determine how many products are received in the shipment of the delivery vehicle, record the receipt of the products in the JIT replenishment management system 100 while matching the products with a delivery list received from the vehicle delivery system.

In one embodiment, in the queue area 160, the unloaded products may be automatically sorted based on the determined priority, time, and amount to be dispensed determined by the JIT inventory replenishment engine 128.

The JIT replenishment management system 100 may further include a picking system which may be configured to retrieve products from the queue area 160 based on the priority, time, and quantity to be dispensed. The picking system may be configured to retrieve from the queue area 160 products to be ordered according to determinations of the JIT inventory replenishment engines 128. The picking system may operate as a sorting module to retrieve the products from the queue area 160 and sort them in a convenient way to be moved to the sales floor 180.

In some embodiments, some associates, like assistants (e.g. robots), may organize and put the products on a plurality of carts based on a priority to he dispensed, a time to he dispensed, a department, a category, a scheduled pickup, etc.

When the carts are full with products, they may be automatically sent out by the assistants to the dispensing area 170 and restocked by the assistants to the shelves based on the priority of each of the products. For example, the carts carried with customer pickup products may be automatically moved and sent to pickup facilities by the assistants. In some embodiments, some assistants can identify broken/damaged products, move them to a special area, and update the product information with the JIT replenishment management system 100.

In some embodiments, the replenishment management system may include another conveyor utilized to autonomously move the products from the queue area 160 to the dispensing area 170.

In some embodiments, the unloaded products may be classified by the conveyor 140 based on stock status, such as out of stock, low stock, and regular stock. Then the sorted products may be sent to the dispensing area 170 for further sorting based on a priority, a time, and a quantity to be dispensed. Different sub-areas within the dispensing area 170 may be designated for more specific categories.

The JIT replenishment management system 100 may be designed to sequence, organize, and optimize different steps of handling products. The products are unloaded from the delivery vehicle and are staged to be ready to go to the shelves.

The dispensing area 170 may be an area where ordered products are moved. The JIT replenishment management system 100 may alert and notify the assistants that the products in the dispensing area 170 are ready to be replenished for the sales floor 180. The JIT replenishment management system may send requests to notify the assistants that the products are ready to be moved the sales floor 180 or pickup facilities, such as an automatic pickup tower, pickup lockers, or other pickup facilities inside the retail store 110.

A local computer device may communicate with and maintain a local database. The local database may include a local inventory record indicating quantities of products available at a local warehouse. The local database may include data describing the products and quantities thereof available, and pending orders.

The JIT replenishment management system 100 can also comprise a notification module configured to provide a notification of a low level inventory of products, for example, messaging to a mobile device (e.g., a smartphone) carried by a store associate. The notification message may also be sent to a screen monitor associated with a store management system. In such way, the inventory level of the products can be adjusted and the products can be replenished if necessary. Also upon receiving a message regarding removal of products from a shelf, a store associate may come to the shelf to check the products and verify whether the products have been purchased or illegally removed. As used herein, the notification module may refer to a notification module combining software and hardware that provides a means of delivering a message to one or more recipients, as known in the art. The “mobile device” may refer to any mobile electronic device with a display and communication capabilities, including a mobile phone, cellular phone, smart phone, tablet computer, laptop computer, personal digital assistant, mobile computing device, navigation system, navigator, and so forth.

The network may include wired and/or wireless networks that enable communications between the various networked devices associated with the example JIT replenishment management system 100, such as the unmanned ground vehicles 150, the inventory replenishment computing device 120, the portable device carried by the store associates. For example, the JIT replenishment management system 100 may communicate with the vehicle delivery system during the transportation of the delivery vehicle to the retail store 110. The JIT replenishment management system 100 may communicate via the network to the unmanned ground vehicles 150 instructions on a quantity of, and location for, product for replenishment, etc.

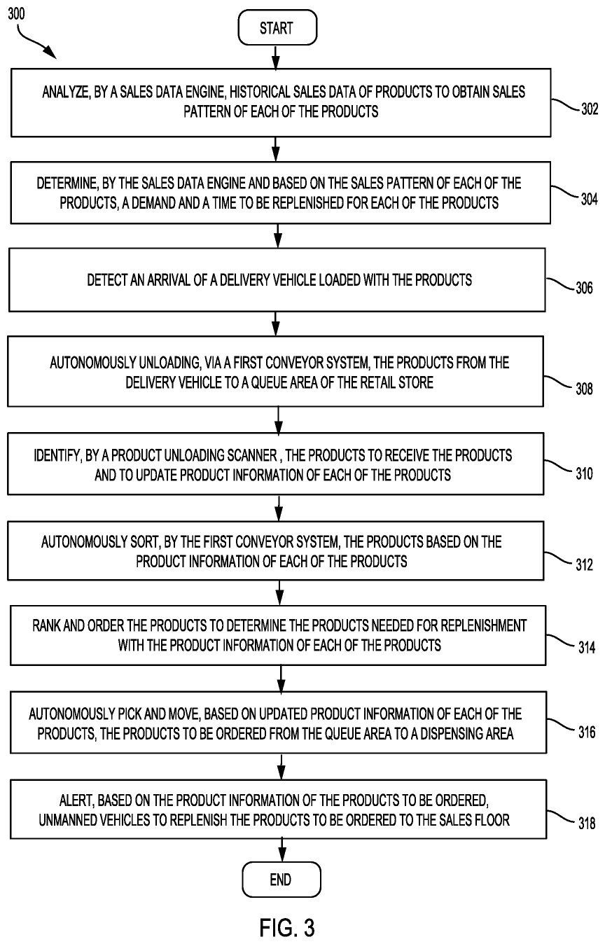

FIG. 3 is a flowchart diagram illustrating an example process 300 for implementing a JIT inventory replenishment management system in accordance with some example embodiments. The example process 300 may be implemented in the above described systems and may include the following steps. Steps may be omitted, combined, or performed in different orders depending on the operations being performed.

At step 302, the sales data engine 126 may analyze historical sales data of each of the products to obtain a sales pattern of the product. The historical sales data of each of the products may be stored in the database which the inventory replenishment computing device 120 can access via the network. The sales data engine 126 may analyze the historical sales data using different calculating modules to obtain a sales pattern of a particular product. The sales pattern may include sales amount, sales rate, predictive sales information, other such sales information, or combination of two or more of such sales information. The sales amount and rate of a product may be associated with timing information (e.g., time of day, time of month, time of year, etc.)

At step 304, based on the sales pattern of each of the products, the sales data engine 126 may determine a quantity and a time to be replenished for each of the products. For example, the sales data engine 126 can analyze the sales amount and rate during a day to determine how many products are needed for replenishment and when to replenish the inventory of the retail store 110. Therefore, the supplier may send the products to the retail store 110 based on a proper demand and a schedule.

At step 306, at least one sensor nearby the delivery vehicle bay of the retail store 110 may detect an arrival of a delivery vehicle loaded with the products. Upon detecting the arrival of the delivery vehicle, the delivery vehicle bay door can automatically open. The sensor may send a signal to the JIT replenishment management system 100 and the vehicle delivery system for confirming the arrival of the delivery vehicle.

At step 308, the conveyor 140 may operate to autonomously unload the products from the delivery vehicle to the queue area 160 of the retail store 110.

At step 310, the product unloading scanner 130 may be configured to scan the bar code printed on the product package, pallet, a case, etc., and to identify the product to be dispensed to the store inventory. The inventory replenishment computing device 120 may receive the scanned information, verify and update the product information accordingly. In the queue area 160, the product unloading scanner 130 may work with some unmanned ground vehicles 150 to sort the products based on the product information and move the sorted products to the carts. The carts may be labeled with priority, department, category, time to be dispensing, etc. The assistants (e.g., robots) may be able to read the label information and automatically attach to the carts, and move the carts to the sales floor 1 based on the labeled information.

At step 312, the conveyor 140 may be coupled with the product unloading scanner 130 and be configured to autonomously move the products based on the product information of each of the products. In one embodiment, the conveyor 140 may sort and move the products based the stock status of the products. For example, the products may first be sorted and moved to different carts in the queue area 160 based on department information of and category and a status of “out-off-stock,” “low stock,” and “in stock.”

At step 314, the JIT inventory replenishment engine 128 may be configured to rank and order the products to determine a priority and a time for each of the products, for replenishment based on the sales pattern and the product information of each of the products, such as the quantity of products on the shelves, stock status, and frozen status. The associates may automatically move the carts to the sales floor 180. The carts may be labeled with a priority to be dispensed, a time to be dispensed, and information of the department and category. For example, the products which are out of stock products or frozen or chilled may be assigned with a highest priority to be dispensed.

The JIT inventory replenishment engine 128 may decide which products need to be put on the shelves and when to put them on the shelves. Moreover, the JIT inventory replenishment engine 128 may decide which products need to move to a pick-up area immediately or move to the sales floor 180 within a certain period of times, such as one hour, two hours, or six hours.

The JIT inventory replenishment engine 128 may analyze the quantity of products on the shelves, sales pattern, and frozen status to decide which products and how many of the products need to be put on shelves at some time, in a proper sequence, or at a certain scheduled time period. In some embodiments, the time to be dispensed for each of the products may be dynamically determined based on the sales pattern of each of the products, a quantity of each of the products displayed on the sales floor 180, and a quantity of each of the products to he dispensed.

Particular products can be put on shelves or sent to pick-up areas at a specific time or in a proper sequence (e.g., immediately, 1 hour later, 2 hours later, etc.) in order to maintain a proper amount of stocked products in the inventory and fulfill customer requirements. For example, a type of bottled water may be sold quickly on weekends during the summer time. The JIT inventory replenishment engine 218 may analyze the sales pattern of the type of bottled water and the quantity of bottled water on the shelves to decide when to restock the bottled water to the sales floor 180 in a specific day with a time frame of 2 hours or 4 hours. In one embodiment, the JIT replenishment management system 100 may monitor the inventory in real time and dynamically adjust and update the time to be dispensed. If the JIT replenishment management system 100 detects a type of bottled water is unexpected in low stock or out of stock, the JIT replenishment management system 100 may automatically notify the unmanned ground vehicle 150 to restock the bottled water immediately, 1 hour later, or two hours later.

At step 316, the unmanned ground vehicles 150 may autonomously identify and move the carts with products from the queue area 180 to the dispensing area 170. The unmanned ground vehicles 150 may automatically recognize and attach to the carts, adjust the connection with the carts, and move the carts to the dispensing area 170.

At step 318, the unmanned ground vehicle 150 may receive a notification to move the carts to the sales floor 180, based on the product information of the products. The unmanned ground vehicle 150 may carry the carts to the sales floor 180 based on the priority, the time to he dispensed of each of the products, and update the product information in the JIT replenishment management system 100. The unmanned ground vehicle 150 may restock the products to the corresponding shelves using an in-store navigation system for maintaining a desired inventory.

In some embodiments, the unmanned ground vehicles 150 may be equipped with the product unloading scanner 130 to scan and identify products from the delivery vehicle. The unmanned ground vehicle 150 may put the products on the conveyor 140 or move the products to the queue area 160, the dispensing area 170, or the sales floor 180 directly. If the delivery vehicle is loaded with one or more products which are in an urgent need and are scheduled to be picked up, the JIT replenishment management system 100 may assign the task to the unmanned ground vehicle 150 to directly identify and pick these products from the delivery vehicle and send them directly to a pickup facility in the retail store 100.

For example, a customer places an order for a kayak which is currently out-of-stock. The kayak is scheduled for the customer to pick up at the retail store 100 at a certain time. The JIT replenishment management system 100 may receive the vehicle delivery information indicating that the kayak is loaded in the delivery vehicle. When the delivery vehicle loaded with the kayak arrives at the retail store 100, the unmanned ground vehicle 150 may identify and pick the kayak from the delivery vehicle and send it directly to pickup facilities in the retail store 100. The pickup facilities may include pickup towers, pickup lockers, and other pickup facilities in the retail store 100. The unmanned ground vehicle 150 may be able to inform the JIT replenishment management system 100 to update the product information and to show the kayak is ready for pickup at the pickup facilities.

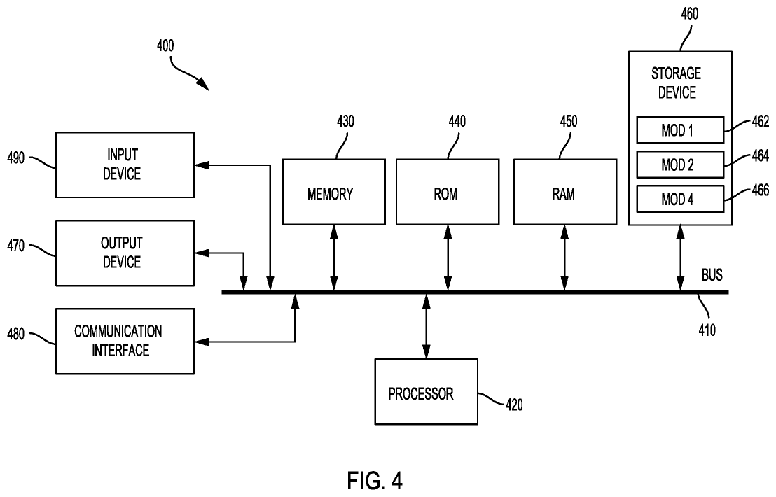

FIG. 4 illustrates an example computer system 400 which can be used to perform the processes for egg quality control as disclosed herein. The exemplary system 400 can include a processing unit (CPU or processor) 420 and a system bus 410 that couples various system components including the system memory 430 such as read only memory (ROM) 440 and random access memory (RAM) 450 to the processor 420. The system 400 can include a cache of high speed memory connected directly with, in close proximity to, or integrated as part of the processor 420. The system 400 copies data from the memory 430 and/or the storage device 460 to the cache for quick access by the processor 420. In this way, the cache provides a performance boost that avoids processor 420 delays while waiting for data. These and other modules can control or be configured to control the processor 420 to perform various actions. Other system memory 430 may be available for use as well. The memory 430 can include multiple different types of memory with different performance characteristics. It can be appreciated that the disclosure may operate on a computing device 400 with more than one processor 420 or on a group or cluster of computing devices networked together to provide greater processing capability. The processor 420 can include any general purpose processor and a hardware module or software module, such as module 1 462, module 2 464, and module 3 466 stored in storage device 460, configured to control the processor 420 as well as a special-purpose processor where software instructions are incorporated into the actual processor design. The processor 420 may essentially be a completely self-contained computing system, containing multiple cores or processors, a bus, memory controller, cache, etc. A multi-core processor may be symmetric or asymmetric.

The system bus 410 may be any of several types of bus structures including a memory bus or memory controller, a peripheral bus, and a local bus using any of a variety of bus architectures. A basic input/output (BIOS) stored in ROM 440 or the like, may provide the basic routine that helps to transfer information between elements within the computing device 400, such as during start-up. The computing device 400 further includes storage devices 460 such as a hard disk drive, a magnetic disk drive, an optical disk drive, tape drive or the like. The storage, device 460 can include software modules 462, 464, 466 for controlling the processor 420. Other hardware or software modules are contemplated. The storage device 460 is connected to the system bus 410 by a drive interface. The drives and the associated computer-readable storage media provide nonvolatile storage of computer-readable instructions, data structures, program modules and other data for the computing device 400. In one aspect, a hardware module that performs a particular function includes the software component stored in a tangible computer-readable storage medium in connection with the necessary hardware components, such as the processor 420, bus 410, display 470, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the device 400 is a small, handheld computing device, a desktop computer, or a computer server.

Although the exemplary embodiment described herein employs the hard disk 460, other types of computer-readable media which can store data that are accessible a computer, such as magnetic cassettes, flash memory cards, digital versatile disks, cartridges, random access memories (RAMs) 450, and read only memory (ROM) 440, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 400, an input device 490 represents any number of input mechanisms, such as a microphone for speech, a touch-sensitive screen for gesture or graphical input, keyboard, mouse, motion input, speech and so forth. An output device 470 can also be one or more of a number of output mechanisms known to those of skill in the art. In some instances, multimodal systems enable a user to provide multiple types of input to communicate with the computing device 400. The communications interface 480 generally governs and manages the user input and system output. There is no restriction on operating on any particular hardware arrangement and therefore the basic features here may easily be substituted for improved hardware or firmware arrangements as they are developed.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

We claim:

1. A computer-implemented method, comprising:
analyzing, by a sales data engine executed by a processor of a computing device, historical sales data of products to obtain a sales pattern of each of the products;
determining, by the sales data engine and based on the sales pattern of each of the products, a demand and a time to be replenished for each of the products;
detecting, by at least one sensor of a retail store, an arrival of a delivery vehicle loaded with the products;
scanning, by a product unloading scanner in communication with the processor, the products to identify each of the products and update product information of each of the products, wherein the product information comprises at least one of a product name, a product code, a location code, a category, a department, a priority to be dispensed, a quantity of the product to be dispensed, a time to be dispensed, a scheduled pickup time, and a supplier;
autonomously unloading, via a first conveyor system, the products from the delivery vehicle to a queue area of the retail store;
ranking and ordering, by an inventory replenishment engine executed by the processor of the computing device and based on the sales pattern and the stock status of each of the products, the products to determine a priority, a quantity, and a time for products to be dispensed;
autonomously sorting, based on the priority, the quantity and the time to be dispensed, the products into a plurality of carts; and
autonomously moving, the products from the queue area to a dispensing area.

2. The method of claim 1, further comprising:
retrieving the products from the queue area based on the priority and the time to be dispensed of each of the products.

3. The method of claim 1, wherein the product unloading scanner is coupled with the first conveyor system.

4. The method of claim 1, wherein sorting the products is based on the priority to be dispensed, the time to be dispensed, and the product category of each of the products.

5. The method of claim 1, further comprising:
autonomously moving, via a second conveyor, the products from the queue area to the dispensing area of the retail store.

6. The method of claim 1, wherein the products are automatically sorted and placed into a plurality of carts based on the product category of each of the products, and wherein the carts are automatically moved by the unmanned ground vehicles to the dispensing area or to the sales floor.

7. The method of claim 1, wherein the products to be ordered are retrieved from the queue area by a picking system based on the priority, the quantity, and the time for products to be dispensed.

8. The method of claim 1, further comprising:
alerting, based on the product information of the products, unmanned ground vehicles to automatically restock the products to the sales floor, wherein the unmanned ground vehicles unload the products from the delivery vehicle and move the products directly to the sales floor.

9. The method of claim 8, further comprises:
moving, by the unmanned ground vehicles, the products from the queue area or the dispensing area to the sales floor based on the priority to be dispensed and the time to be dispensed.

10. The method of claim 1, wherein the time to be dispensed of each of the products is dynamically determined based on the sales pattern of each of the product, a quantity of each of the products displayed on the sales floor, and a frozen status.

11. A system, comprising:
one or more sensors at a retail store, wherein at least one sensor is configured to detect an arrival of a delivery vehicle loaded with products;
a product unloading scanner; one or more of unmanned ground vehicles;
a computing device, comprising:
a processor; and
non-transitory computer-readable storage medium having instructions stored which, when executed by the processor, cause the processor to perform operations comprising:
analyzing, by a sales data engine executed by the processor, historical sales data of products to obtain a sales pattern of each of the product;
determining, by the sales data engine and based on the sales pattern of each of the products, a demand and a time to be replenished for each of the products;
upon detecting the arrival of a delivery vehicle, autonomously unloading, by a first conveyor system, the products from the delivery vehicle to a queue area of the retail store;
scanning, by a product unloading scanner in communication with the processor, the products to identify the products and to update product information of each of the products;
ranking and ordering, by an inventory replenishment engine executed by the processor of the computing device and based on the sales pattern and stock status of each of the products, each of the products to determine a priority, a quantity, and a time for products to be dispensed;
autonomously sorting the products into a plurality of carts, based on the priority, the quantity, and the time to be dispensed for products; and
autonomously moving, based on the priority, the quantity, and the time to be dispensed, the products from the queue area to a dispensing area.

12. The system of claim 11, further comprising the executable instructions operative to cause the processor to perform the operations comprising:
retrieving the products from the queue area based on the priority and the time to be dispensed of each of the products.

13. The system of claim 11, wherein the product information comprises at least one of a product name, a product code, a location code, frozen status, a product category, a product department, a priority to be dispensed, a quantity of the product to be dispensed, a time to be dispensed, a scheduled pickup time, and a supplier.

14. The system of claim 11, wherein the products to be ordered are retrieved from the queue area by a picking system based on the priority, the quantity, and the time for products to be dispensed.

15. The system of claim 11, wherein a second conveyor is utilized to autonomously move the products from the queue area to the dispensing area of the retail store.

16. The system of claim 11, wherein the products are automatically sorted and placed into a plurality of carts based on the product category of each of the products, and wherein the carts are automatically moved by unmanned ground vehicles to the dispensing area.

17. The system of claim 16, further comprising alerting, based on the product information of the products, unmanned ground vehicles to automatically restock the products to the sales floor.

18. The system of claim 16, wherein the unmanned ground vehicles unload products from the delivery vehicle and move the products directly to the sales floor.

19. The system of claim 16, wherein the unmanned vehicles are in communication with the processor to move the products from the queue area or the dispensing area to the sales floor based on the priority to be dispensed and the time to be dispensed.

20. The system of claim 11, wherein the time to be dispensed of each of the products is dynamically determined based on the sales pattern of each of the product, a quantity of each of the products displayed on the sales floor, and a quantity of each of the product to be dispensed.
